(19) United States
(12) Patent Application Publication
(10) Pub. No.: US 2002/0158889 A1
(43) Pub. Date: Oct. 31, 2002

(54) Wireless display system for operating and monitoring plural personal computers

(76) Inventors: Osamu Sameshima, Osaka (JP); Osamu Kamo, Kobe-Shi (JP); Masaki Mukai, Nishinomiya-Shi (JP); Atsushi Tanaka, Osaka (JP)

Correspondence Address: MCDERMOTT, WILL & EMERY, 600 13th Street, N.W., Washington, DC, 20005-3096, US

(21) Appl. No.: 09/843,152

(22) Filed: Apr. 27, 2001

(51) Int. Cl. G09G 5/00

(52) U.S. Cl. 345/636

(57) ABSTRACT

According to the wireless display system of the invention, by wireless communication of display data of plural personal computers to one wireless display, and divided simultaneous display, plural personal computers can be always monitored simultaneously, and moreover can be operated individually by using one wireless display. Therefore, the supervisor can monitor and operate plural personal computers simultaneously without moving around, so that the problems of physical burden of supervisor, lowering of quality of working and learning, and tremendous cost of installation and maintenance can be solved at the same time.

### BACKGROUND OF THE INVENTION

1. Field of the Invention

The present invention relates to a wireless display system for monitoring and operating plural personal computers by remote control from the wireless display.

2. Description of the Related Art

When one supervisor operates and/or monitors plural personal computers installed at remote places for control of devices or operation of long processing time, or when one manager manages progress of work such as data input in personal computers by plural workers, the supervisor or manager used to move from one personal computer to other, and checks the screen, enters input by using keys or mouse, or instructs the workers.

Or in a personal computer education class, one tutor instructs operations to plural students, and then moves among students to check and guide individually. For the improvement of labor and guidance of the tutor, the equipment having an exclusive display device for teacher, and personal computers of students are connected by wires, and the screens of personal computers of students are changed over and operated on the screen of the teacher's display device, but such educational facility (known as laboratory class) is expensive.

The method of the supervisor, manager or tutor moving among plural personal computers, workers or students requires a large physical burden if executed consecutively. Besides, when the supervisor or tutor is staying at a certain personal computer, the situation of other personal computers, their workers or other students cannot be inspected, it lacks in quick response or monitoring effect. As a result, the quality of working or learning may be lowered.

The education facility requires a fixed place of use and a tremendous expense for installation and maintenance, and it is hence limited to a case of continuous use in consideration of the cost.

### SUMMARY OF THE INVENTION

According to the wireless display system of the invention, by wireless transmission of display data of plural personal computers to one wireless display, and divided simultaneous display, plural personal computers can be always monitored simultaneously and moreover can be operated individually by using one wireless display. The supervisor can monitor and operate plural personal computers simultaneously without moving around, so that the problems of physical burden of supervisor, lowering of quality of working and learning, and tremendous cost of installation and maintenance can be solved at the same time.

### BRIEF DESCRIPTION OF THE DRAWINGS

FIG. 1 is a block diagram of wireless display system.

FIG. 2 is a block diagram at the personal computer side of the invention.

FIG. 3 is a block diagram of wireless display in a first embodiment of the invention.

FIG. 4 is a block diagram of wireless display in a second embodiment of the invention.

### DETAILED DESCRIPTION OF THE EXEMPLARY EMBODIMENTS

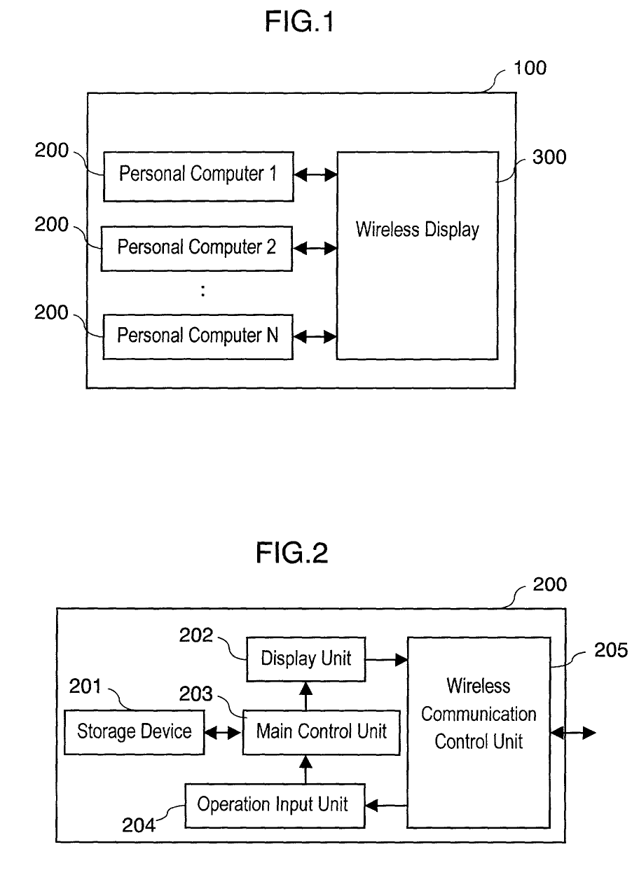

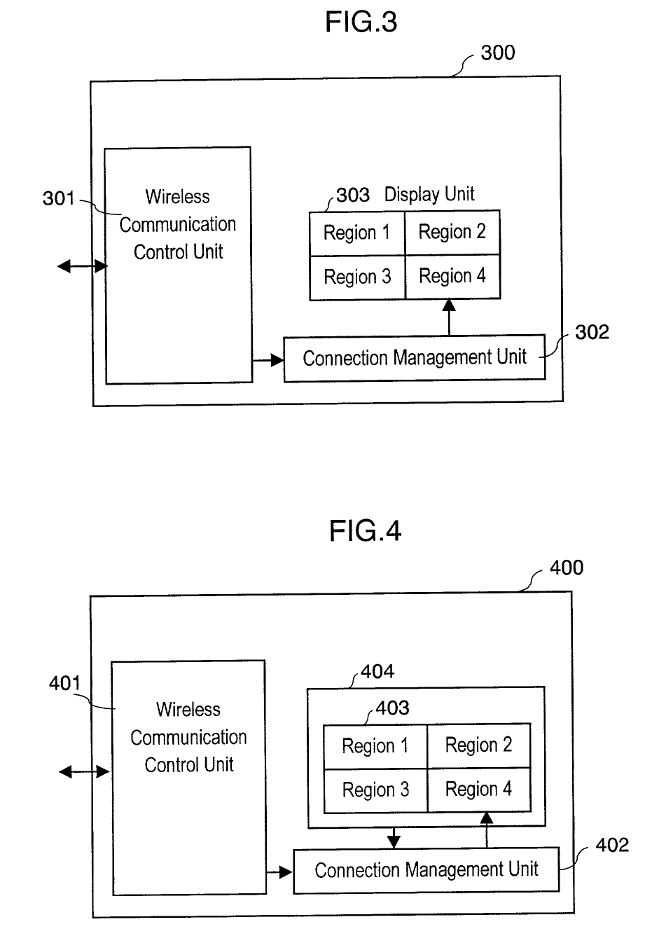

Preferred embodiments of the invention are specifically described below by referring to FIG. 1, FIG. 2, FIG. 3 and FIG. 4.

(Embodiment 1)

FIG. 1 shows a wireless display system 100 in embodiment 1, in which wireless communication is done mutually between plural (n herein) personal computers 200 and one wireless display 300.

As shown in FIG. 2, the personal computer 200 has a wireless communication control unit 205, in addition to basic components of personal computer comprising a storage device 201, a display unit 202, a main control unit 203, and an operation input unit 204. (The personal computer also comprises other components, but those not relating directly to the invention are omitted.)

The wireless communication control unit 205 acquires display data displayed in the display unit 202, converts into transmission data having a protocol format conforming to the wireless communication system with the wireless display 300, and transmits by wireless means.

In the wireless display 300 shown in FIG. 3, a wireless communication processing unit 301 receives the transmission data sent from the wireless communication processing unit 205 of the personal computer, interprets the data, converts into the information for identifying the personal computer at the sender's side (hereinafter called machine number) and display data, and transfers to a connection management unit 302.

The connection management unit 302 converts the display data transferred from the wireless communication processing unit 301 into text and graphic information suited to divided display, and transfers to a display unit 303 together with the machine number. In the converting operation, the display size of display data is reduced depending on the number of units connected, and the display position is changed according to the machine number.

The display unit 303 in FIG. 3 shows an example of display when four personal computers are connected to the wireless display. The display data is reduced to 1/2 in the horizontal and vertical direction, and the display area is reduced to 1/4, and when the display data is coming from a first personal computer, the display position is changed to the relative position in region 1.

The display unit 303 accepts the display position and display data received in the wireless communication processing unit 301 and converted in the connection management unit 302, and displays as text and graphic information. As a result, as shown in the example in FIG. 3, the display data of four personal computers is simultaneously displayed as being reduced to 1/4 size in regions 1, 2, 3 and 4, respectively.

When monitoring the operation of personal computers by the display unit of the wireless display only, the display unit 202 of the personal computer requires only the storage function of display data, and does not always require display device and function.

For acquisition of display data by the wireless control unit 205, from the viewpoint of operating speed, it is preferred to read the content of the so-called graphic memory storing the display content in the display unit 202 by hardware means. Further, instead of transmitting all the acquired display content, it is preferred to hold the immediately preceding display content in the storage device provided in the wireless control unit 205, compare with newly acquired display content, and transmit only the changed portion, and therefore the quantity of data is curtailed, and the operating speed is made faster. These methods of acquiring the display content are not essential for the invention, but may be realized by other method, for example, by using a system service presented by the OS (such as BitBlt reading in Windows system) for specifying the screen position and reading the display content. In such a case, the operating speed is not so fast, but the circuit for reading the graphic memory by hardware means can be simplified, and the cost can be lowered.

In this explanation, screens of plural personal computers are displayed simultaneously in the display unit of the wireless display, but screens of plural personal computers may be changed over and displayed, or while displaying screens of some of plural personal computers simultaneously in one part, other's can be changed over and displayed in other part.

Moreover, the monitoring and managing function may be reinforced by changing the color of the corresponding screen of the display unit of the wireless display, or blinking to attract attention when a specified key is entered in the personal computer or a predetermined screen is displayed.

(Embodiment 2)

Embodiment 2 of the invention is explained by referring to FIGS. 1, 2 and 4, relating only to those different from embodiment 1.

The wireless display of embodiment 2 shown in FIG. 4 comprises a touch panel 304, in addition to the wireless display of embodiment 1 shown in FIG. 3.

The touch panel 304 is a transparent film device capable of recognizing the contact position and contact data (make or break) when the panel is touched, and it is installed on the display unit 303 for covering it. When the user touches the display position of the screen of a desired personal computer among screens of plural personal computers divided and displayed simultaneously in the display unit 303, the touch panel 304 creates operation data and transfers to the connection management unit 302.

The connection management unit 302 receives the operation data from the touch panel 304, and identifies the machine number of the personal computer of the intended operation, and transfers to the wireless communication processing unit 301 to transmit to the intended personal computer. That is, judging the contact position belongs to which region of the display unit 303, it is designed to transmit to the personal computer corresponding to the region through the wireless communication processing unit 301.

The wireless communication processing unit 301 converts the operation data received from the connection management unit 302 into transmission data of protocol format conforming to the wireless communication system, and transmits to the wireless communication processing unit 205 of the intended personal computer.

The wireless communication control unit 205 receives the transmission data sent from the wireless display 300, converts into operation input data having the same format as the operation data created by manipulation of keyboard or pointing device (such as mouse) of the personal computer 200, and transfers to the operation input unit 204.

The operation input unit 204 receives the operation input data, interprets it as the same input as the manipulation of keyboard or pointing device (such as mouse) of the personal computer 200, and transfers to the main control unit 203. The main control unit 203 controls same as in ordinary input, displays the result in the display unit 202, and further displays in the display unit 303 of the wireless display 300 by the same procedure as explained in embodiment 1.

In this explanation, the individual personal computers are manipulated, but by preparing a screen for common operation in the wireless display, and employing the communication protocol of group transmission or broadcast transmission, it is also possible to specify plural personal computers and operate the same simultaneously. It is useful for batch initialization of control devices, or presentation of subjects to all students in class or group.

As the input function of the wireless display, the touch panel is explained, but so far as the portability is not sacrificed, other input device may be used, and the effects of the invention are unchanged.

In embodiments 1 and 2, one wireless display is used, but plural wireless displays may be used, and the functions and operations can be distributed among plural supervisors or managers simultaneously.

As described herein, according to the invention, by dividing and displaying screen contents of plural personal computers acquired by mutual wireless communication in one wireless display, the state of personal computers can be always monitored. As a result, the physical labor of the user is lessened, the installation and maintenance cost is saved, and the quality of work is improved by the enhancement of monitoring effect.

Further, by manipulating the display regions divided and displayed in the wireless display by touch panel, in addition to continuous monitoring, remote control operation is realized, and these effects can be further enhanced.

What is claimed is:

1. A wireless display system comprising:
plural personal computers having wireless communication function; and
a wireless display having wireless communication function and display function,
wherein screens of some of the plural personal computers are displayed in the display unit of the wireless display through wireless communication.

2. The wireless display system of claim 1,
wherein screens of some of the plural personal computers are displayed simultaneously by dividing the display unit of the wireless display.

3. The wireless display system of claim 1,
wherein when changing over and displaying the screens of plural personal computers in the wireless display, the screen is changed to a desired personal computer according to transmission of a specific code from the desired personal computer, or information identifying the desired personal computer is displayed.

4. The wireless display system of claim 1,
wherein the wireless display further has an input function, and the plural personal computers are operated through wireless communication by using the input function of the wireless display.

5. The wireless display system of claim 4,
wherein some of the plural personal computers are operated by simultaneously displaying the screens of some of the plural personal computers by dividing the display unit of the wireless display.

6. The wireless display system of claim 4 or 5,
wherein the wireless display further includes a touch panel, and the touch panel has the input function.

7. The wireless display system of claim 6,
wherein a common operation screen of plural personal computers is displayed in the wireless display, and same operation is done simultaneously in the plurality of personal computers.

8. The wireless display system of claim 6,
wherein a desired personal computer to be operated is specified by touching the personal computer screen displayed in the wireless display by the touch panel.
